(19) United States
(12) Patent Application Publication
(10) Pub. No.: US 2026/0056926 A1
(43) Pub. Date: Feb. 26, 2026

(54) DATA MODEL OPTIMIZATION SYSTEM, DATA MODEL OPTIMIZATION METHOD, AND COMPUTER READABLE MEDIUM

(71) Applicant: Mitsubishi Electric Corporation, Tokyo (JP)

(72) Inventors: Megumi SUZUKI, Tokyo (JP); Takahisa ENOMOTO, Tokyo (JP); Keita SAITO, Tokyo (JP); Yoshitaka OTAKI, Tokyo (JP)

(73) Assignee: Mitsubishi Electric Corporation, Tokyo (JP)

(21) Appl. No.: 19/361,350

(22) Filed: Oct. 17, 2025

Related U.S. Application Data
(63) Continuation of application No. PCT/JP2023/022197, filed on Jun. 15, 2023.

(51) Int. Cl. G06F 16/22

(52) U.S. Cl. CPC G06F 16/221

(57) ABSTRACT

A calculation unit (110) calculates for each column in a plurality of tables, a call count which is the number of times that the column is called when data is acquired according to a data acquisition scenario, based on database configuration information. The calculation unit (110) calculates for each column set in the plurality of tables, a call count which is the number of times that the column set is called at the same timing when data is acquired from a database according to the data acquisition scenario. The calculation unit (110) calculates for each column set in the plurality of tables, a similarity degree between names of columns. A generation unit (130) generates a data model based on the call count for each column, the call count for each column set, and the similarity degree for each column set.

### CROSS REFERENCE TO RELATED APPLICATION

This application is a Continuation of PCT International Application No. PCT/JP2023/022197, filed on Jun. 15, 2023, which is hereby expressly incorporated by reference into the present application.

### TECHNICAL FIELD

The present disclosure relates to technology for generating a data model for an application.

### BACKGROUND ART

Patent Literature 1 proposes technology for generating new data in JSON format using data described in JSON format and a conversion formula described in JSON format.

### CITATION LIST

### Patent Literature

Patent Literature 1: JP 2017-535854 A

### SUMMARY OF INVENTION

### Technical Problem

Patent Literature 1 does not propose technology for regenerating a conversion formula based on evaluation of the conversion formula described in JSON format.

Therefore, it is not possible to generate a data model that is suitable for an application by considering consolidation and division of tables in a database.

The present disclosure aims to make it possible to generate a data model that is suitable for an application.

### Solution to Problem

A data model optimization system according to the present disclosure includes:
a single call count calculation unit to calculate for each column in a plurality of tables, a call count which is the number of times that the column is called when data is acquired from a database according to a data acquisition scenario, based on database configuration information that indicates a configuration of the plurality of tables in the database and the data acquisition scenario in which the data to be acquired from the database is specified;
a set call count calculation unit to calculate for each column set in the plurality of tables, a call count which is the number of times that the column set is called at the same timing when data is acquired from the database according to the data acquisition scenario, based on the database configuration information and the data acquisition scenario;
a similarity degree calculation unit to calculate for each column set in the plurality of tables, a similarity degree between names of columns, based on the database configuration information; and
a data model generation unit to generate a data model for representing data to be acquired according to the data acquisition scenario, using a structure that is suitable for processing of an application that uses the data, based on the call count for each column, the call count for each column set, and the similarity degree for each column set.

### Advantageous Effects of Invention

According to the present disclosure, it is possible to generate a data model that is suitable for an application.

### BRIEF DESCRIPTION OF DRAWINGS

FIG. 1 is a configuration diagram of a data model optimization system 100 in Embodiment 1.

FIG. 2 is a configuration diagram of a data processing system 200 in Embodiment 1.

FIG. 3 is a functional configuration diagram of the data processing system 200 in Embodiment 1.

FIG. 4 is a flowchart of a data model optimization method in Embodiment 1.

FIG. 5 is a flowchart of the data model optimization method in Embodiment 1.

FIG. 6 is a diagram illustrating an example of a configuration of a database 212 in Embodiment 1.

FIG. 7 is a diagram illustrating an example of a data acquisition scenario D02 in Embodiment 1.

FIG. 8 is a diagram illustrating an example of a first edition model D20 in Embodiment 1.

FIG. 9 is a diagram illustrating an example of a data conversion image in Embodiment 1.

FIG. 10 is a diagram illustrating an example of a data model D31 in Embodiment 1.

FIG. 11 is a diagram illustrating an example of the data model D31 in Embodiment 1.

FIG. 12 is a diagram illustrating an example of the data model D31 in Embodiment 1.

FIG. 13 is a diagram illustrating an example of a functional configuration of the data processing system 200 in Embodiment 1.

FIG. 14 is a functional configuration diagram of the data processing system 200 in Embodiment 2.

FIG. 15 is a flowchart of the data model optimization method in Embodiment 2.

FIG. 16 is a flowchart of the data model optimization method in Embodiment 2.

FIG. 17 is a flowchart of the data model optimization method in Embodiment 2.

FIG. 18 is a hardware configuration diagram of the data model optimization system 100 in Embodiment.

### DESCRIPTION OF EMBODIMENTS

In the Embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

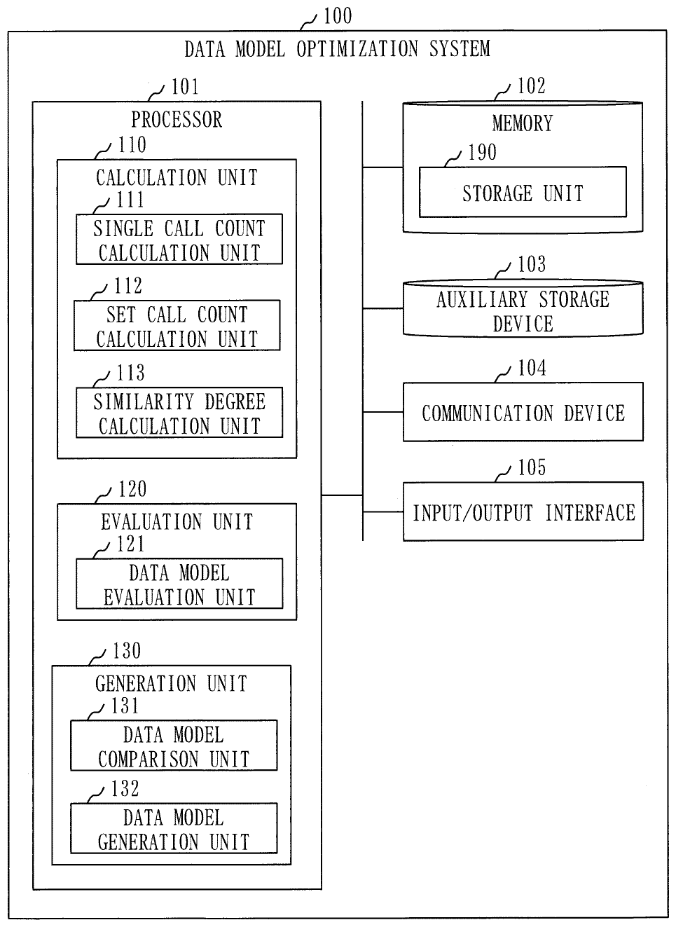

A data model optimization system 100 will be described based on FIGS. 1 to 13.

### ***Description of Configuration***

A configuration of the data model optimization system 100 will be described based on FIG. 1.

The data model optimization system 100 is a computer that includes hardware pieces such as a processor 101, a memory 102, an auxiliary storage device 103, a communication device 104, and an input/output interface 105. These pieces of hardware are connected with one another through signal lines.

The data model optimization system 100 may also be configured with a plurality of computers instead of being configured with a single computer (device).

The processor 101 is an IC that performs arithmetic processing and controls other pieces of hardware. The processor 101 is, for example, a CPU.

IC is an abbreviation for Integrated Circuit.

CPU is an abbreviation for Central Processing Unit.

The memory 102 is a volatile or non-volatile storage device. The memory 102 is also referred to as a main storage device or a main memory. The memory 102 is, for example, an RAM. Data stored in the memory 102 is stored in the auxiliary storage device 103 as necessary.

RAM is an abbreviation for Random Access Memory.

The auxiliary storage device 103 is a non-volatile storage device. The auxiliary storage device 103 is, for example, an ROM, an HDD, a flash memory, or a combination of these. Data stored in the auxiliary storage device 103 is loaded into the memory 102 as necessary.

ROM is an abbreviation for Read Only Memory.

HDD is an abbreviation for Hard Disk Drive.

The communication device 104 is a receiver and a transmitter. The communication device 104 is, for example, a communication chip or an NIC. Communication of the data model optimization system 100 is performed using the communication device 104.

NIC is abbreviation for Network Interface Card.

The input/output interface 105 is a port to witch an input device and an output device are connected. The input/output interface 105 is, for example, a USB port. The input device is, for example, a keyboard or a mouse. The output device is, for example, a display. Input and output of the data model optimization system 100 are performed using the input/output interface 105.

USB is an abbreviation for Universal Serial Bus.

The data model optimization system 100 includes elements such as a calculation unit 110, an evaluation unit 120, and a generation unit 130. These elements are implemented by software.

The calculation unit 110 includes elements such as a single call count calculation unit 111, a set call count calculation unit 112, and a similarity degree calculation unit 113.

The evaluation unit 120 includes an element such as a data model evaluation unit 121.

The generation unit 130 includes elements such as a data model comparison unit 131 and a data model generation unit 132.

The auxiliary storage device 103 stores a data model optimization program to cause a computer to function as the calculation unit 110, the evaluation unit 120, and the generation unit 130. The data model optimization program is loaded into the memory 102 and executed by the processor 101.

The auxiliary storage device 103 further stores an OS. At least a part of the OS is loaded into the memory 102 and executed by the processor 101.

While executing the OS, the processor 101 also executes the data model optimization program.

OS is an abbreviation for Operating System.

Input and output data of the data model optimization program is stored in a storage unit 190.

The memory 102 functions as the storage unit 190. However, storage devices such as the auxiliary storage device 103, a register in the processor 101, and a cache memory in the processor 101 may also function as the storage unit 190 instead of the memory 102 or together with the memory 102.

The data model optimization program can be recorded (stored) in a non-volatile recording medium such as an optical disc or a flash memory, in a computer readable format.

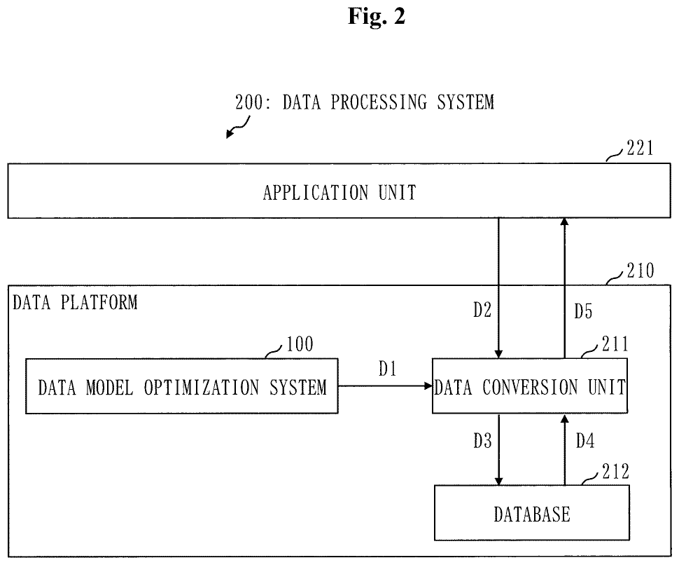

A configuration of a data processing system 200 will be described based on FIG. 2.

The data processing system 200 is a computer system that utilizes the data model optimization system 100.

The data processing system 200 includes a data platform 210 and an application unit 221.

The data platform 210 is a computer system that includes a data model optimization system 100, a data conversion unit 211, and a database 212.

The data conversion unit 211 is an element that executes data conversion software, and implemented by processing circuitry (a processor, for example) of the computer. The data conversion software causes the computer to function as the data conversion unit 211.

The application unit 221 is an element that executes an application program for data processing, and implemented by the processing circuitry of the computer. The application program causes the computer to function as the application unit 221.

The data model optimization system 100 is introduced into a communication system between the application unit 221 and the data platform 210.

The data model optimization system 100 generates a data model D1 and sends the data model D1 to the data conversion unit 211. The data conversion unit 211 receives the data model D1.

The application unit 221 sends a data request D2 to the data platform 210. The data conversion unit 211 receives the data request D2.

The data conversion unit 211 acquires from the database 212, data D4 required by the data request D2 through an inquiry D3 to the database 212.

The data conversion unit 211 converts the data D4 into data D5 based on the data model D1, and sends the data D5 to the application unit 221.

The application unit 221 receives the data D5 and performs data processing using the data D5.

The data model D1 is a data model that represents only data that is necessary for an application, from abundant data (DB) of the source, using a structure (format and grouping) that is suitable for processing of the application.

The data model D1 converts the data D4 into the data D5 in the following manner, for example. The data model D1 represents a “person” whose internal structure includes name, age, and gender. Then, the disparate data D4 such as “suzuki”, “26”, and “Female” is obtained from the database 212. In this case, the data model D1 stores “suzuki” in the internal structure of “name”, stores “26” in the internal structure of “age”, and stores “Female” in the internal structure of “gender”. Thus, the data D4 is converted into the data D5 that represents a “person” named suzuki”. The application uses such grouped data D5.

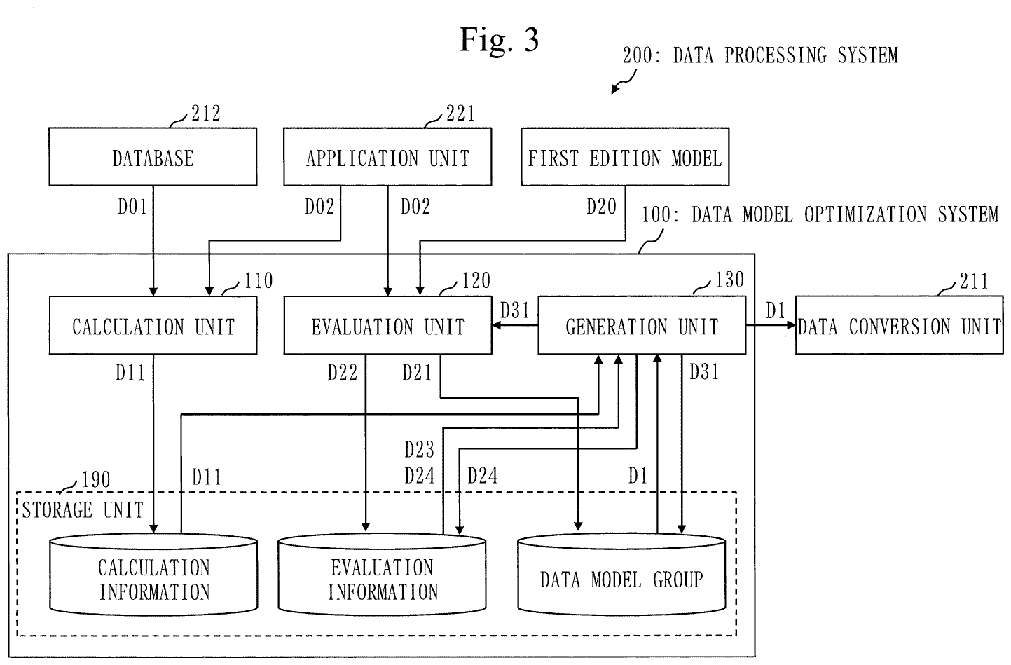

FIG. 3 illustrates a functional configuration of the data model optimization system 100.

A function of each element in the data model optimization system 100 and data that is inputted and outputted between elements will be described below.

### ***Description of Operation***

A procedure of operation of the data model optimization system 100 is equivalent to a data model optimization method. Further, the procedure of the operation of the data model optimization system 100 is equivalent to a procedure of processing by the data model optimization program.

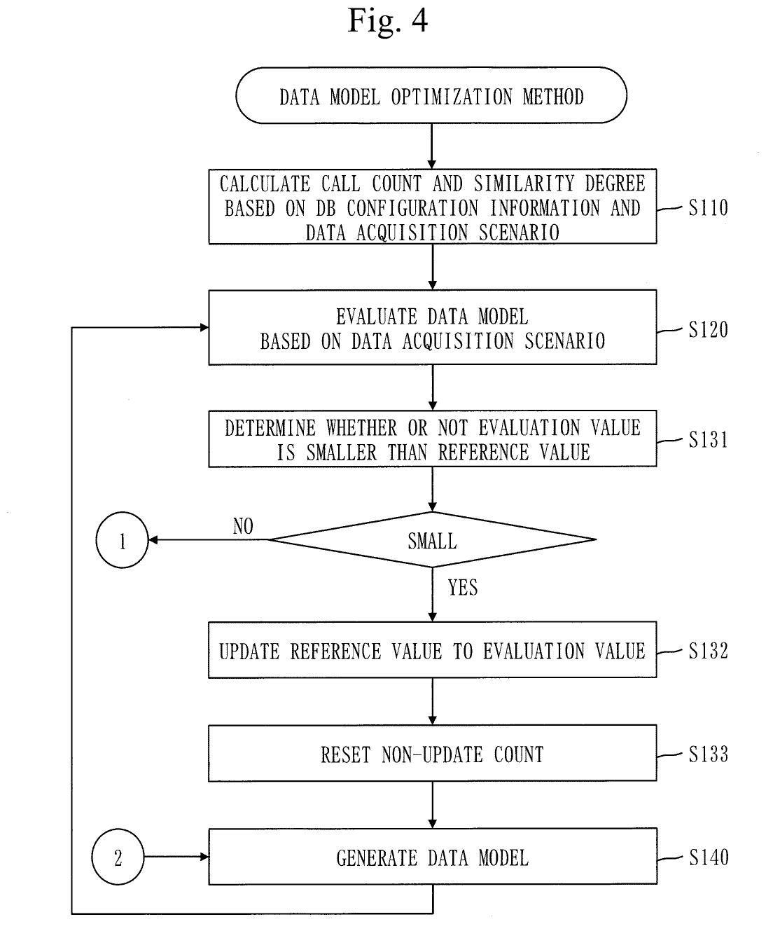

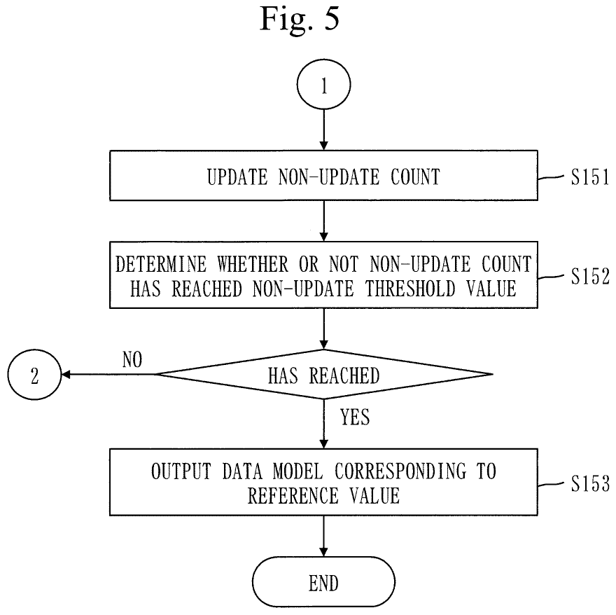

The data model optimization method will be described based on FIGS. 4 and 5.

In step S110, the calculation unit 110 calculates a call count for each column, a call count for each column set, and a similarity degree for each column set, based on database configuration information D01 and a data acquisition scenario D02.

The database configuration information D01 is data that indicates configurations of a plurality of tables in the database 212. The database configuration information D01 is acquired from, for example, the database 212.

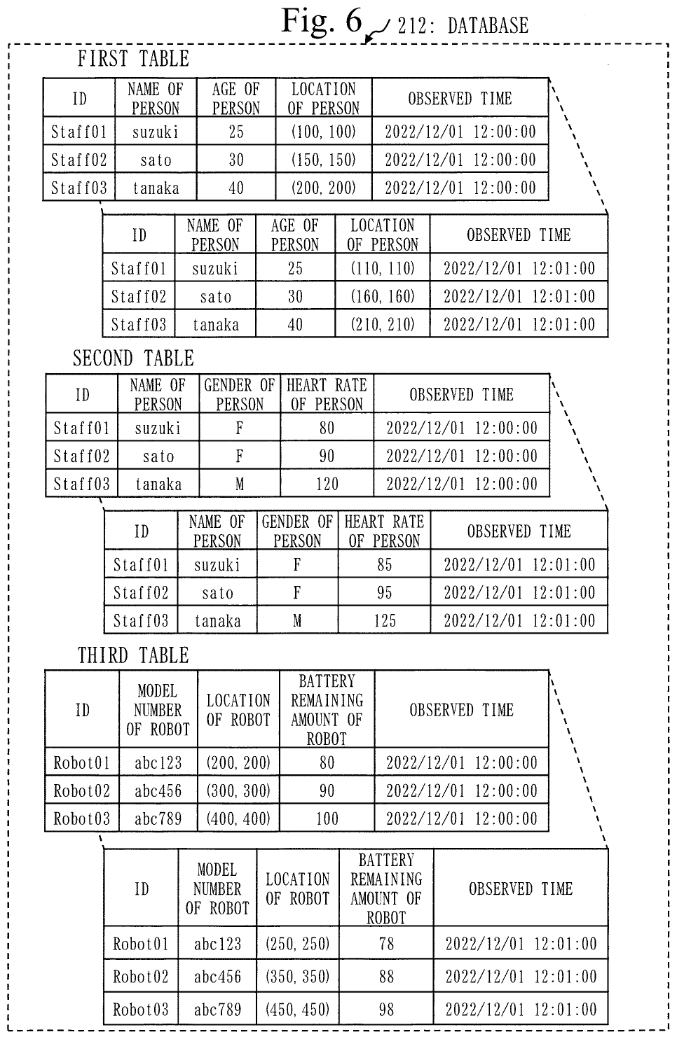

FIG. 6 illustrates an example of the configurations of the plurality of tables in the database 212.

The database 212 has the first table, the second table, and the third table. Time series data is registered in each table.

The first table has columns such as “ID”, “name of person”, “age of person”, “location of person”, and “observed time”.

The second table has columns such as “ID”, “name of person”, “gender of person”, “heart rate of person”, and “observed time”.

The third table has columns such as “ID”, “model number of robot”, “location of robot”, “battery remaining amount of robot”, and “observed time”.

The database configuration information D01 indicates such a configuration of the database 212.

Returning to FIG. 4, the description of step S110 will be continued.

The data acquisition scenario D02 is data in which data to be acquired from the database 212 is specified. The data acquisition scenario D02 is acquired from, for example, the application unit 221.

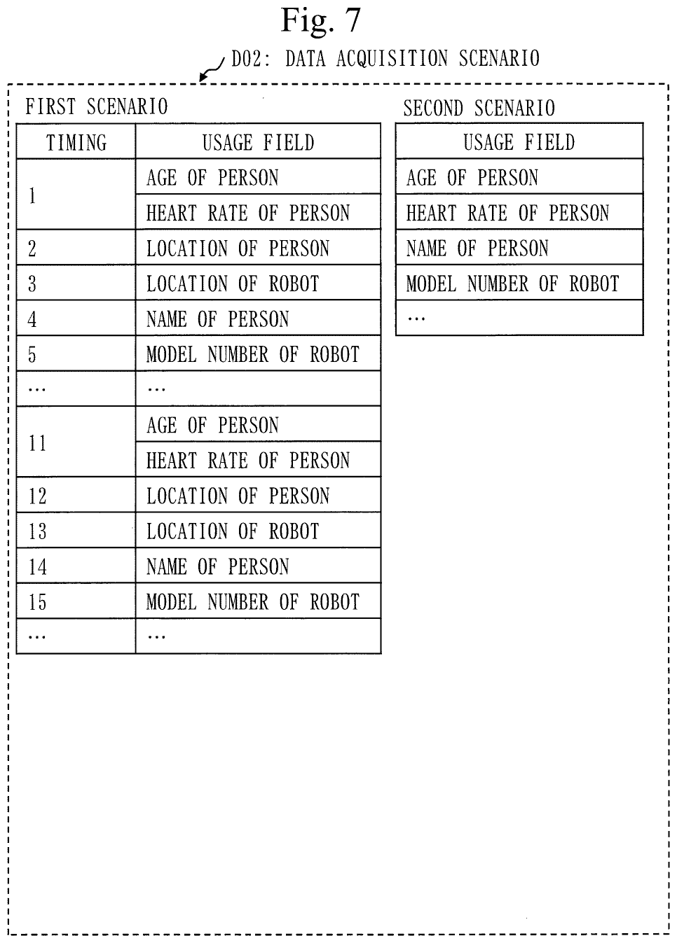

FIG. 7 illustrates an example of the data acquisition scenario D02.

The first scenario indicates to acquire data of each column specified in the usage field section in the order specified in the timing section.

Data of two or more columns specified in the usage field section at the same timing is acquired at the same timing. The term “same timing” may also be interpreted as “simultaneous”.

The second scenario indicates to acquire data of a plurality of columns specified in the usage field section in bulk.

Returning to FIG. 4, details of step S110 will be described.

The single call count calculation unit 111 calculates the call count for each column in the plurality of tables indicated in the database configuration information D01 based on the data acquisition scenario D02. The calculated call count is the number of times that the column is called when data is acquired from the database 212 according to the data acquisition scenario D02.

An example of calculating the call count for each column will be described based on the first scenario in FIG. 7.

In the first scenario, the column “age of person” is specified in the usage field section of both the first timing and the eleventh timing.

Therefore, when the column “age of person” is not specified in the usage field section from the fifteenth timing onwards, the call count for the column “age of person” is 2.

For the second scenario, the call count for each column specified in the usage field section is 1, and the call count for other columns is 0.

Returning to FIG. 4, the description of step S110 will be continued.

The set call count calculation unit 112 calculates the call count for each column set in the plurality of tables indicated in the database configuration information D01 based on the data acquisition scenario D02. The calculated call count is the number of times that the column set is called at the same timing when data is acquired from the database 212 according to the data acquisition scenario D02.

The column set consists of two or more columns. Each of all combinations in all columns in all tables in the database 212 is the column set, for example.

An example of calculating the call count for each column set will be described based on the first scenario in FIG. 7.

In the first scenario, the set of the column “age of person” and the column “heart rate of person” is specified in each usage field section of the first timing and the eleventh timing.

Therefore, when the set of the column “age of person” and the column “heart rate of person” is not specified in the usage field section from the fifteenth timing onwards, the call count for the set of the column “age of person” and the column “heart rate of person” is 2.

For the second scenario, the call count for each column set specified in the usage field section is 1, and the call count for other column sets is 0.

Returning to FIG. 4, the description of step S110 will be continued.

The similarity degree calculation unit 113 calculates the similarity degree for each column set in the plurality of tables indicated in the database configuration information D01. The calculated similarity degree is a similarity degree between names of columns included in the column set.

An example of calculating the similarity degree for each column set will be described based on FIG. 6.

When the character strings between the names of the columns are completely consistent with each other, the similarity degree of the column set is a value calculated by multiplying the number of columns by a standard value. The number of columns refers to the number of columns included in the column set.

The column “name of person” in the first table and the column “name of person” in the second table are completely consistent with each other in terms of the character string “name of person” for each name.

Therefore, when the standard value is 10, the similarity degree of the set of the column “name of person” in the first table and the column “name of person” in the second table is a value “20” that is calculated by multiplying the standard value “10” by the number of columns “2”.

When the character strings between the names of the columns are not completely consistent with each other, the similarity degree of the column set is a value calculated by multiplying the number of columns by the number of common words. The number of common words refers to the number of words that is common in the character strings between the names of the columns.

The column “location of person” in the first table and the column “location of robot” in the third table are common in terms of a single word “location” in the character strings of each name.

Therefore, the similarity degree of the set of the column “location of person” in the first table and the column “location of robot” in the third table is a value “2” that is calculated by multiplying the number of common words “1” by the number of columns “2”.

Returning to FIG. 4, the description of step S110 will be continued.

The single call count calculation unit 111 stores the call count for each column in the storage unit 190.

The set call count calculation unit 112 stores the call count for each column set in the storage unit 190.

The similarity degree calculation unit 113 stores the similarity degree for each column set in the storage unit 190.

Data that indicates the call count for each column, the call count for each column set, and the similarity degree for each column set is referred to as calculation information D11.

In step S120, a data model evaluation unit 121 evaluates a data model D21 based on the data acquisition scenario D02, and calculates an evaluation value of the data model D21.

The data model D21 is data that indicates a rule for representing data to be acquired according to the data acquisition scenario D02, using a structure that is suitable for processing of an application that uses the data.

In step S120 at the first time, a first edition model D20 is evaluated.

The first edition model D20 is the data model D21 that is generated in advance. The first edition model D20 is inputted into the data model optimization system 100, and the data model evaluation unit 121 receives the inputted first edition model D20, for example.

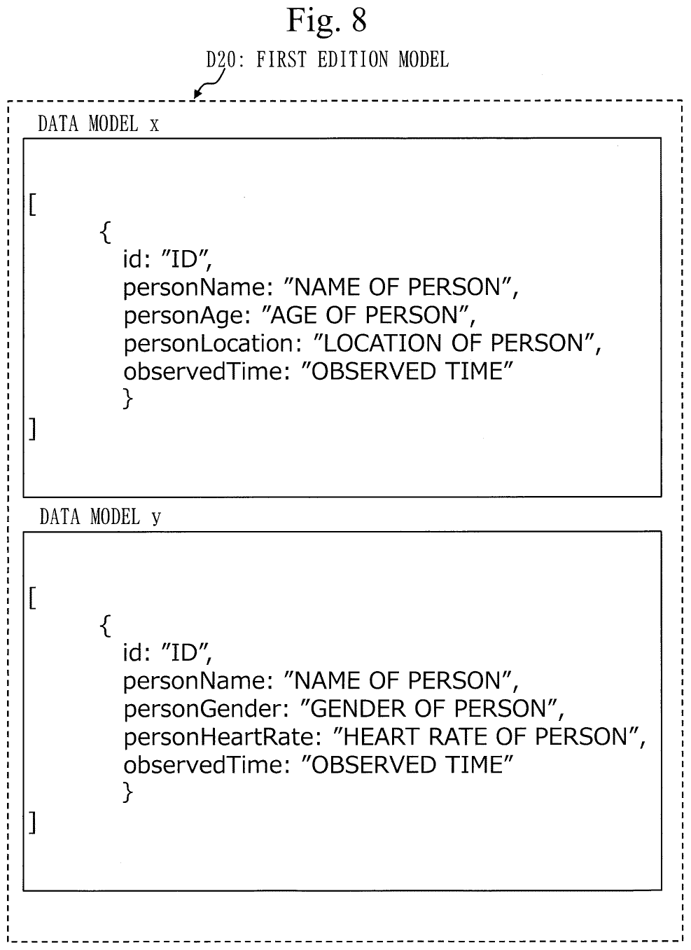

FIG. 8 illustrates an example of the first edition model D20.

The first edition model D20 indicates rules for representing data to be acquired from each table in the database 212, using a structure that is suitable for processing of an application that uses the data.

A data model x is the first edition model D20 for the first table.

A data model y is the first edition model D20 for the second table.

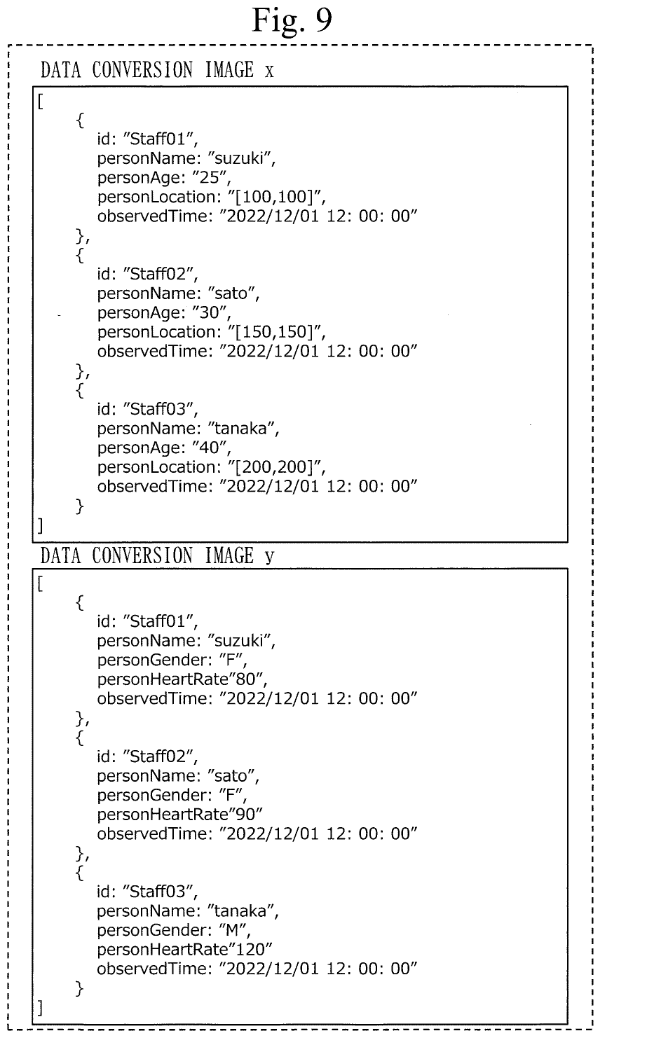

FIG. 9 illustrates an example of data whose structure has been converted according to the first edition model D20.

A data conversion image x represents data whose structure has been converted according to the data model x.

A data conversion image y represents data whose structure has been converted according to the data model y.

Returning to FIG. 4, the description of step S120 will be continued.

In step S120 from the second time onwards, a data model D31 generated in step S140 is evaluated as the data model D21.

The data model D31 is stored in the storage unit 190 and is read out from the storage unit 190.

The evaluation value (score) of the data model D21 is a value obtained by evaluating the data model D21 based on an evaluation axis. The evaluation axis refers to standards, rules, conditions, or the like for evaluation.

An example of the evaluation axis is the number of times of inquiries to the database 212. The number of times of inquiries is equivalent to the number of times of accesses to the table.

The evaluation axis may be data communication volume or the number of data models. The evaluation axis may be a combination of elements such as the number of times of inquiries, the data communication volume, and the number of data models. The evaluation axis may be an item that relates to communication performance. Alternatively, other items may be the evaluation axis.

In Embodiment 1, the smaller the evaluation value is, the higher the evaluation of the data model D21 is, and the larger the evaluation value is, the lower the evaluation of the data model D21 is.

The evaluation value of the data model is calculated as follows.

When the data model to be evaluated is used, the data model evaluation unit 121 simulates a behavior of the data processing system 200 (especially at least one of the data conversion unit 211 and the application unit 221). Then, the data model evaluation unit 121 calculates the evaluation value of the data model based on a result of simulation.

An example of calculating the evaluation value will be described.

In the example, the evaluation axis is the number of times of inquiries to the database 212. The database 212 has the tables illustrated in FIG. 6. Further, the data acquisition scenario D02 is the first scenario in FIG. 7, and the data model D21 to be evaluated is the first edition model D20 in FIG. 8.

First, the data model evaluation unit 121 calculates the evaluation value at each timing indicated in the first scenario.

At the first timing, data of each of “age of person” and “heart rate of person” is acquired. “Age of person” is a column in the first table, and “heart rate of person” is a column in the second table. Therefore, when the first edition model D20 is used, an inquiry occurs to the first table in the database 212 and another inquiry occurs to the second table in the database 212. That is, the number of times of inquiries to the database 212 is 2. Therefore, the evaluation value for the first timing is 2.

Then, the data model evaluation unit 121 adds up the evaluation value for each timing. A total value to be calculated is the evaluation value of the first edition model D20.

The description of step S120 will be continued. The evaluation value calculated for the data model D21 is referred to as an evaluation value D23.

The data model evaluation unit 121 stores evaluation information D22 in the storage unit 190.

The evaluation information D22 indicates the evaluation value D23 of the data model D21 in association with an identifier of the data model D21.

The data model evaluation unit 121 stores the data model D21 in the storage unit 190.

In step S131, the data model comparison unit 131 compares the latest evaluation value D23 with a reference value D24, and determines whether or not the evaluation that is represented by the latest evaluation value D23 is higher than the evaluation that is represented by the reference value D24.

Specifically, the data model comparison unit 131 determines whether or not the latest evaluation value D23 is smaller than the reference value D24.

When the latest evaluation value D23 is smaller than the reference value D24, the evaluation that is represented by the latest evaluation value D23 is higher than the evaluation that is represented by the reference value D24.

When the latest evaluation value D23 is larger than the reference value D24, the evaluation that is represented by the latest evaluation value D23 is lower than the evaluation that is represented by the reference value D24.

The latest evaluation value D23 is the evaluation value D23 of the latest data model D21 among the generated data models D21. That is, the latest evaluation value D23 is the evaluation value D23 calculated in the previous step S120. The latest evaluation value D23 is read out from the storage unit 190.

The reference value D24 is an evaluation value that represents the highest evaluation among one or more evaluation values D23 for one or more data models D21 generated prior to the latest data model D21. That is, the reference value D24 is the minimum evaluation value among one or more evaluation values D23 for one or more data models D21 generated prior to the latest data model D21. The reference value D24 to be used in step S131 at the first time is an initial value (the maximum value, for example). The reference value D24 is stored in the storage unit 190 and read out from the storage unit 190.

When the latest evaluation value D23 is smaller than the reference value D24, that is, when the evaluation that is represented by the latest evaluation value D23 is higher than the evaluation that is represented by the reference value D24, the process proceeds to step S132.

When the current evaluation value D23 is equal to or greater than the reference value D24, that is, when the evaluation that is represented by the latest evaluation value D23 is lower than the evaluation that is represented by the reference value D24, the process proceeds to step S151.

In step S132, the data model comparison unit 131 updates the reference value D24 to the latest evaluation value D23.

In step S133, the data model comparison unit 131 resets a non-update count to zero.

The non-update count is the number of times that the reference value D24 has not been updated. The non-update count is stored in the storage unit 190.

In step S140, the data model generation unit 132 generates the data model D31 based on the calculation information D11.

The data model D31 is generated in such a way that the evaluation value D23 of the data model D31 becomes small. That is, the data model D31 is generated in such a way that the evaluation that is represented by the evaluation value D23 of the data model D31 becomes high.

The data model D31 is generated by at least one of methods (1) to (3) indicated in the following.

(1) The data model D31 is generated as follows.

First, the data model generation unit 132 selects the column set whose call count is high based on the call count for each column set. A set count threshold value is used for selection. The set count threshold value is stored in the storage unit 190. The selected column set is referred to as an object column set.

Specifically, the data model generation unit 132 compares the call count for each column set with the set count threshold value, and selects the column set whose call count is equal to or greater than the set count threshold value, as the object column set.

Then, the data model generation unit 132 generates only for the object column set among the column sets in the plurality of tables indicated in the database configuration information D01, the data model D31 for representing data of each column in the object column set, using a structure that is suitable for processing of an application that uses the data.

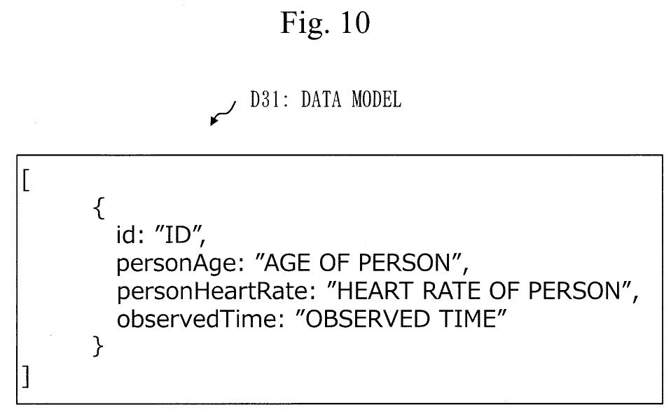

FIG. 10 illustrates an example of the data model D31 to be generated by the method (1). The data model D31 in FIG. 10 will be described below.

When the first scenario in FIG. 7 is used, the set of the column “age of person” and the column “heart rate of person” is called at the first timing and the eleventh timing. That is, the call count for the set of the column “age of person” and the column “heart rate of person” is 2. When the set count threshold value is less than or equal to 2, the set of the column “age of person” and the column “heart rate of person” is the object column set.

In the database 212 in FIG. 6, “age of person” is a column in the first table, and “heart rate of person” is a column in the second table. When the first edition model D20 in FIG. 8 is used, the evaluation value D23 based on the number of times of inquiries, the data communication volume, or the like becomes high because conversion is performed for each table.

Then, in order to lower the evaluation value D23, the data model D31 in FIG. 10 is generated.

The data model D31 in FIG. 10 is the data model D31 for representing each data of the column “age of person” and the column “heart rate of person”, using a structure that is suitable for processing of an application that uses the data.

The column “ID” and the column “observed time” are items that are necessary when data is read out. Therefore, the name for each of the column “ID” and the column “observed time” is indicated in the data model D31.

(2) The data model D31 is generated as follows.

First, the data model generation unit 132 selects the column set whose similarity degree is high among combinations of columns whose call count is high, based on the call count for each column and the similarity degree for each column set. A single count threshold value and a similarity degree threshold value are used for selection. The single count threshold value and the similarity degree threshold value are stored in the storage unit 190. The selected column set is referred to as an object column set.

Specifically, the data model generation unit 132 compares the call count for each column with the single count threshold value, and selects each column whose call count is equal to or greater than the single count threshold value, as an object column. Then, the data model generation unit 132 compares for each column set which is a combination of object columns, the similarity degree of the column set with the similarity degree threshold value, and selects among column sets each of which is a combination of object columns, the column set whose similarity degree is equal to or greater than the similarity degree threshold value, as the object column set.

Then, the data model generation unit 132 generates only for the object column set among the column sets in the plurality of tables indicated in the database configuration information D01, the data model D31 for representing data of each column in the object column set, using a structure that is suitable for processing of an application that uses the data.

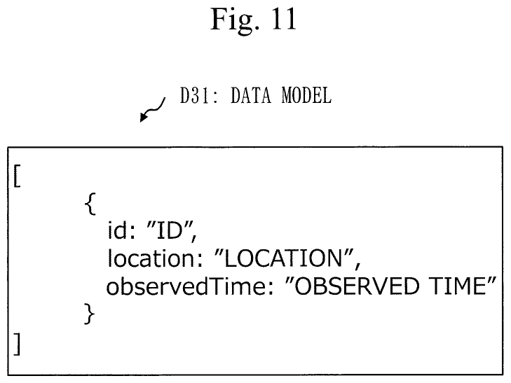

FIG. 11 illustrates an example of the data model D31 to be generated by the method (2). The data model D31 in FIG. 11 will be described below.

When the first scenario in FIG. 7 is used, the column “location of person” is called at the second timing and the twelfth timing. Further, the column “location of robot” is called at the third timing and the thirteenth timing. That is, the call count for each of the column “location of person” and the column “location of robot” is 2. When the single count threshold value is less than or equal to 2, each of the column “location of person” and the column “location of robot” is the object column.

In the database 212 in FIG. 6, “location of person” is a column in the first table, and “location of robot” is a column in the third table. When the first edition model D20 is used, the evaluation value D23 based on the number of times of inquiries, the data communication volume, or the like becomes high because conversion is performed for each table.

Since the word “location” is common in the set of the column “location of person” and the column “location of robot”, the similarity degree of the column set is high. Therefore, the similarity degree of the set of the column “location of person” and the column “location of robot” is equal to or greater than the similarity degree threshold value.

Then, in order to lower the evaluation value D23, the data model D31 in FIG. 11 is generated.

The data model D31 in FIG. 11 is the data model D31 for representing each data of the column “location of person” and the column “location of robot”, using “location” which is a structure that is suitable for processing of an application that uses the data.

When there are a plurality of common words in character strings between names of columns, the data model D31 indicates conversion of the plurality of common words.

(3) The data model D31 is generated as follows.

First, the data model generation unit 132 selects the column set whose similarity degree is low among combinations of columns whose call count is high, based on the call count for each column and the similarity degree for each column set. A single count threshold value and a similarity degree threshold value are used for selection. The single count threshold value and the similarity degree threshold value are stored in the storage unit 190. The selected column set is referred to as an object column set.

Specifically, the data model generation unit 132 compares the call count for each column with the single count threshold value, and selects each column whose call count is equal to or greater than the single count threshold value, as an object column. Then, the data model generation unit 132 compares for each column set which is a combination of object columns, the similarity degree of the column set with the similarity degree threshold value, and selects among column sets each of which is a combination of object columns, the column set whose similarity degree is less than the similarity degree threshold value, as the object column set.

Then, the data model generation unit 132 generates only for the object column set among the column sets in the plurality of tables indicated in the database configuration information D01, the data model D31 for representing data of each column in the object column set, using a separate structure that is suitable for processing of an application that uses the data.

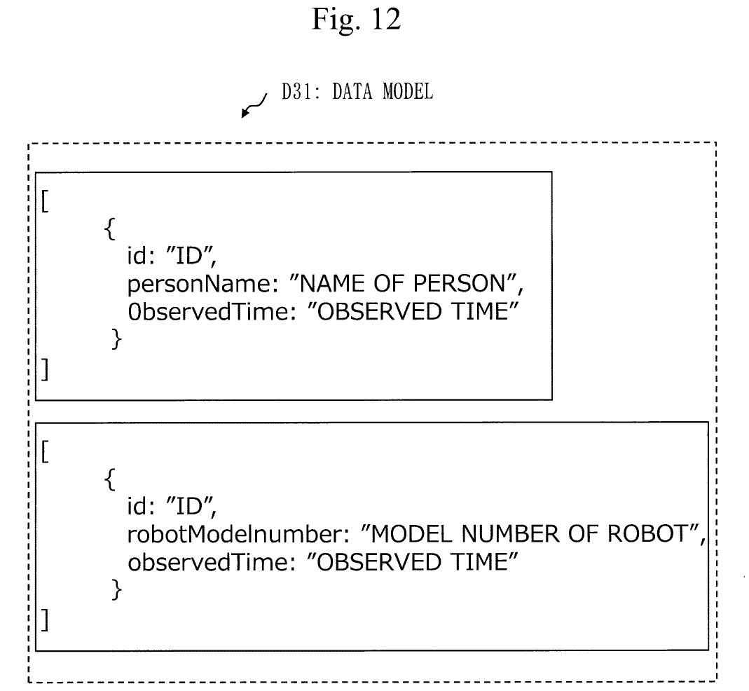

FIG. 12 illustrates an example of the data model D31 to be generated by the method (3). The data model D31 in FIG. 12 will be described below.

When the first scenario in FIG. 7 is used, the column “name of person” is called at the fourth timing and the fourteenth timing. Further, the column “model number of robot” is called at the fifth timing and the fifteenth timing. That is, the call count for each of the column “name of person” and the column “model number of robot” is 2. When the single count threshold value is less than or equal to 2, each of the column “name of person” and the column “model number of robot” is the object column.

In the database 212 in FIG. 6, “name of person” is a column in the first table and the second table, and “model number of robot” is a column in the third table. When the first edition model D20 is used, the evaluation value D23 based on the number of times of inquiries or the data communication volume becomes high because conversion is performed for each table.

Since there is no common word in the set of the column “name of person” and the column “model number of robot”, the similarity degree of the column set is low. Therefore, the similarity degree of the set of the column “name of person” and the column “model number of robot” is less than the similarity degree threshold value.

Then, in order to lower the evaluation value D23, the data model D31 in FIG. 12 is generated.

The data model D31 in FIG. 12 is the data model D31 for representing each data of the column “name of person” and the column “model number of robot”, using a separate (individual) structure that is suitable for processing of an application that uses the data.

The description of step S140 will be continued.

The data model generation unit 132 modifies each of the set count threshold value, the single count threshold value, and the similarity degree threshold value.

The threshold value such as the set count threshold value, the single count threshold value, or the similarity degree threshold value is modified as follows by utilizing machine learning, for example.

The data model generation unit 132 modifies the threshold value to an appropriate value using a learned model. The learned model is generated in advance and stored in the storage unit 190.

The learned model is generated by a learning device. The learning device is, for example, a device that is separate from the data model optimization system 100.

The learning device generates the learned model by learning learning data using a convolutional neural network (CNN), for example.

The learning data indicates a relation between the threshold value and the evaluation value of the data model. The learning data indicates a relation between the threshold value used in another data model optimization system and the evaluation value of the data model generated by the other data model optimization system, for example.

Returning to FIG. 4, the description of step S140 will be continued.

The data model generation unit 132 passes the data model D31 to the data model evaluation unit 121. Further, the data model generation unit 132 stores the data model D31 in the storage unit 190.

After step S140, the process proceeds to step S120.

Proceeding to FIG. 5, the description will be continued from step S151.

In step S151, the data model comparison unit 131 updates the non-update count by adding 1 to the non-update count.

In step S152, the data model comparison unit 131 compares the non-update count with a non-update threshold value, and determines whether or not the non-update count has reached the non-update threshold value.

The non-update threshold value is a threshold value for the non-update count, and is stored in the storage unit 190 in advance.

When the non-update count has reached the non-update threshold value, the process proceeds to step S153.

When the non-update count has not reached the non-update threshold value, the process proceeds to step S140.

In step S153, the data model comparison unit 131 outputs the data model D1.

The data model D1 is the data model D21 corresponding to the reference value D24.

The data model D1 is outputted as follows.

First, the data model comparison unit 131 selects the evaluation information D22 that indicates the same evaluation value D23 as the reference value D24, and acquires a data model identifier from the selected evaluation information D22.

Next, the data model comparison unit 131 acquires from the storage unit 190, the data model D21 that is identified by the acquired data model identifier.

Then, the data model comparison unit 131 outputs the acquired data model D21 as the data model D1. The outputted data model D1 is inputted to the data conversion unit 211.

After step S153, the process ends.

### ***Effects of Embodiment 1***

Embodiment 1 aims to generate a data model that is suitable for each application by considering consolidation and division of tables in a database by simulating a behavior of a communication system of the application, and to optimize communication efficiency.

The data model optimization system 100 repeats generation of the data model based on the call count of a column and the column similarity degree, and evaluation of the data model based on the evaluation axis.

The data model optimization system 100 includes a calculation unit 110, an evaluation unit 120, and a generation unit 130.

The calculation unit 110 calculates the call count of a single column, the call count in a combination of columns, and the column similarity degree, based on the database configuration and the data acquisition scenario of the application.

The evaluation unit 120 aggregates based on the evaluation axis when data is acquired by using the data model in the application based on the data model and data acquisition scenario of the application.

The generation unit 130 compares the evaluation value based on an evaluation result with the minimum value of a data model evaluation result after system start-up. When the evaluation value exceeds the minimum value of the data model evaluation result after system start-up, the generation unit 130 generates a data model in such a way that the evaluation value becomes small based on the evaluated data model, the column call count, and the column similarity degree.

Thereby, it is possible to generate a data model that is suitable for each application by considering consolidation and division of tables in a database, and to optimize communication efficiency.

The generation unit 130 generates a data model as follows, based on the column call count, the column similarity degree, and the evaluated data model.

The generation unit 130 generates the data model that converts only a combination of columns whose simultaneous call count for the columns is high.

The generation unit 130 generates the data model that converts only a column whose call count for the single column is high and column similarity degree is high.

The generation unit 130 generates the data model that converts only a single column whose call count for the single column is high and whose column similarity degree is low.

Thereby, it is possible to generate a data model that is suitable for each application by considering consolidation and division of tables in a database.

The calculation unit 110 calculates the column similarity degree using a character string of a name of each column in a table of the database, based on the database configuration and the data acquisition scenario of the application.

Thereby, when a data model is generated, it is possible to generate the data model that can convert columns whose column similarity degrees are high by the same data model.

The generation unit 130 compares a data model evaluation value with the minimum value of a data model evaluation result after system start-up. Then, in any of the following cases, the generation unit 130 generates a new data model in such a way that the data model evaluation value becomes small based on the column call count, the column similarity degree, and the evaluated data model

The generation unit 130 generates the new data model when the data model evaluation value falls below the minimum value of the data model evaluation result after system start-up.

The generation unit 130 generates the new data model when the data model evaluation value exceeds the minimum value of the data model evaluation result after system start-up, but the non-update count for the minimum value of the data model evaluation result after system start-up has not reached a threshold value.

Thereby, it is possible to generate a data model that is more efficient in communication and is suitable for an application.

The generation unit 130 compares the data model evaluation value with the minimum value of the data model evaluation result after system start-up. When the data model evaluation value exceeds the minimum value of the data model evaluation result after system start-up, and the non-update count for the minimum value of the data model evaluation result after system start-up has reached the threshold value, the generation unit 130 outputs the data model. The data model to be outputted is a data model whose data model evaluation value is the minimum value of the data model evaluation result after system start-up.

Thereby, it is possible to output an appropriate data model, and optimize communication efficiency.

### ***Practical Example of Embodiment 1***

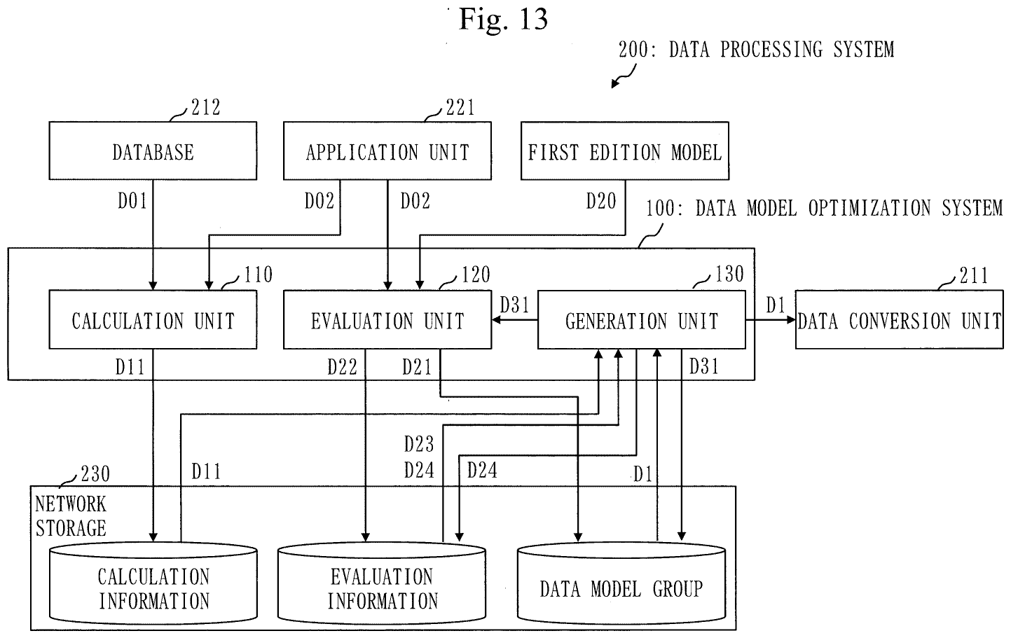

FIG. 13 illustrates an example of a functional configuration of the data processing system 200.

Input/output data of the data model optimization system 100 may be stored in a network storage 230 instead of or in addition to the storage unit 190.

The network storage 230 is a storage unit that is provided in an external unit of the data model optimization system 100 and is configured with one or more storage devices.

By communicating with the network storage 230, the data model optimization system 100 stores data in the network storage 230, and also acquires data from the network storage 230.

### ***Supplements to Embodiment 1***

When data in various fields such as those in a smart city is dealt with, a data platform is constructed for collection and management of data.

In data integration that crosses a boundary of fields, a software infrastructure is used that can handle data with a common model between applications.

This type of software infrastructure converts the data according to a data model defined in an interface part of the data platform, and provides the converted data to the applications.

Therefore, communication efficiency between the applications and the data platform depends on the data model.

Embodiment 1 is the technology of a function that is implemented within a data platform where various data is handled such as in a smart city.

A developer of an application may not be aware of the database configuration of the data platform. Thus, the data acquisition scenario of the application indicates only a field of data to be used and the order in which the data is used.

### Embodiment 2

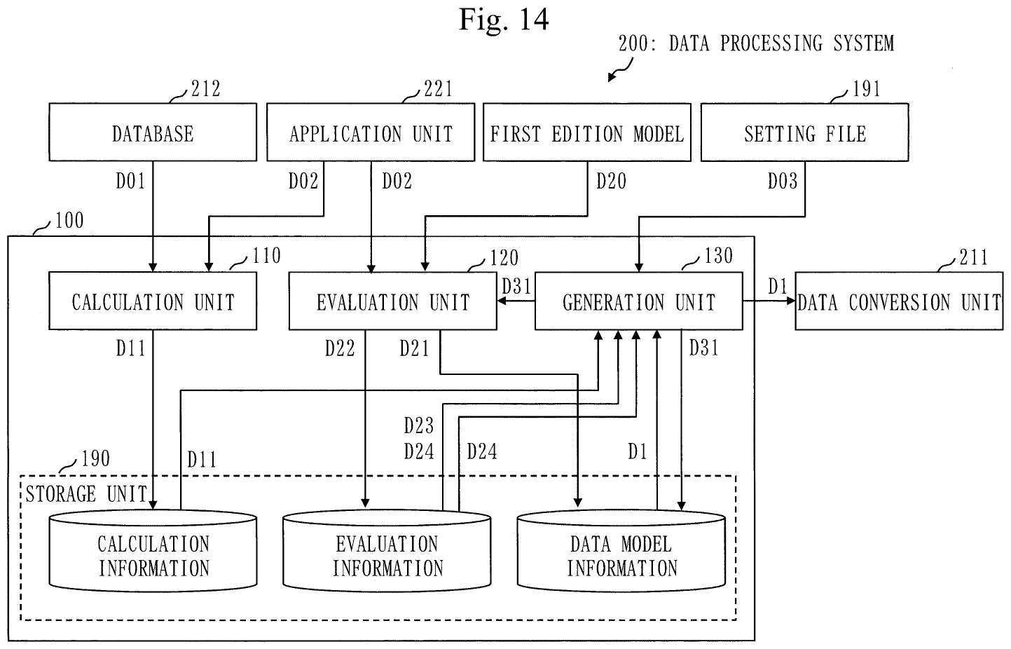

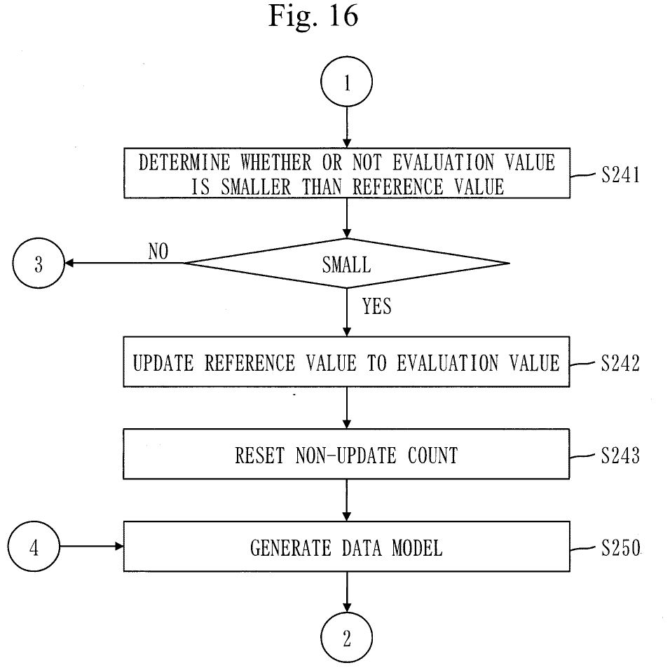

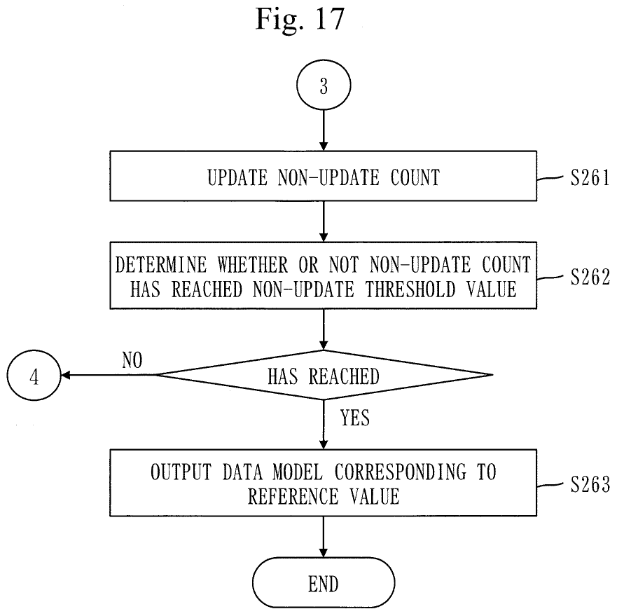

Regarding the embodiment of outputting the data model D1 for which evaluation to be targeted has been obtained, differences from Embodiment 1 will be mainly described based on FIGS. 14 to 17.

### ***Description of Configuration***

The configuration of the data processing system 200 will be described based on FIG. 14.

The configuration of the data processing system 200 is the same as the configuration in Embodiment 1.

However, in the data processing method, a target value D03 is used. The target value D03 is a value that represents evaluation to be targeted and is set in a setting file 191.

### ***Description of Operation***

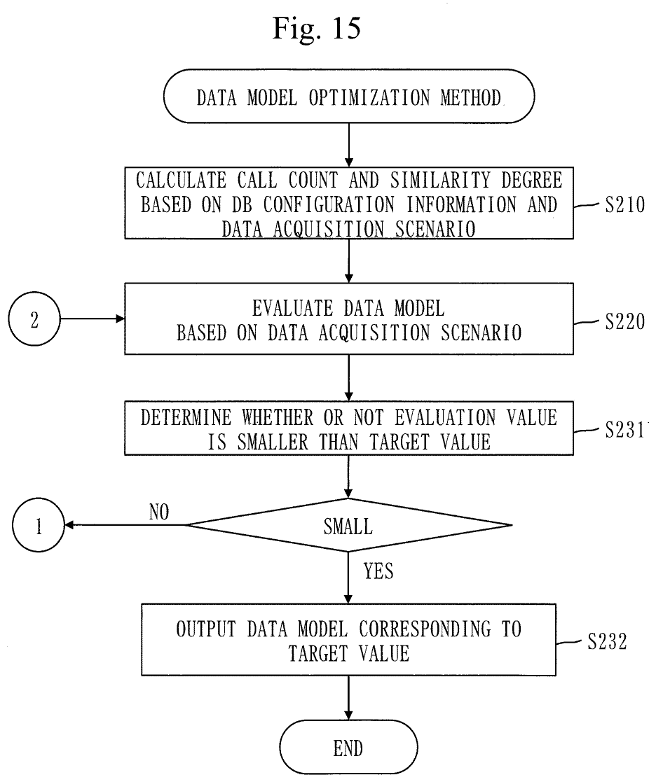

The data model optimization method will be described based on FIGS. 15 to 17.

In step S210, the calculation unit 110 calculates a call count for each column, a call count for each column set, and the similarity degree for each column set, based on the database configuration information D01 and the data acquisition scenario D02.

Step S210 is the same as step S110 in Embodiment 1.

In step S220, the data model evaluation unit 121 evaluates the data model D21 based on the data acquisition scenario D02, and calculates an evaluation value of the data model D21.

Step S220 is the same as step S120 in Embodiment 1.

In step S231, the data model comparison unit 131 compares the latest evaluation value D23 with the target value D03, and determines whether or not evaluation that is represented by the latest evaluation value D23 is higher than evaluation that is represented by the target value D03.

Specifically, the data model comparison unit 131 determines whether or not the latest evaluation value D23 is smaller than the target value D03.

When the latest evaluation value D23 is smaller than the target value D03, the evaluation that is represented by the latest evaluation value D23 is higher than the evaluation that is represented by the target value D03.

When the latest evaluation value D23 is greater than the target value D03, the evaluation that is represented by the latest evaluation value D23 is lower than the evaluation that is represented by the target value D03.

The target value D03 is obtained from the setting file 191.

The setting file 191 is stored in the storage unit 190 in advance, for example.

When the latest evaluation value D23 is smaller than the target value D03, that is, when the evaluation that is represented by the latest evaluation value D23 is higher than the evaluation that is represented by the target value D03, the process proceeds to step S232.

When the current evaluation value D23 is equal to or greater than the target value D03, that is, when the evaluation that is represented by the latest evaluation value D23 is lower than the evaluation that is represented by the target value D03, the process proceeds to step S241.

In step S232, the data model comparison unit 131 outputs the data model D1.

The data model D1 is the data model D21 corresponding to the latest evaluation value D23. That is, the data model D1 is the latest data model D21.

The data model D1 is outputted as follows.

First, the data model comparison unit 131 selects the evaluation information D22 that indicates the latest evaluation value D23, and acquires a data model identifier from the selected evaluation information D22.

Next, the data model comparison unit 131 acquires from the storage unit 190, the data model D21 that is identified by the acquired data model identifier.

Then, the data model comparison unit 131 outputs the acquired data model D21 as the data model D1. The outputted data model D1 is inputted into the data conversion unit 211.

After step S232, the process ends.

The process when the latest evaluation value D23 is equal to or greater than the target value D03 in step S231 is the same as the process of the steps from step S131 onwards in Embodiment 1.

That is, steps S241 through S243 are the same as steps S131 through S133 in Embodiment 1.

Further, step S250 is the same as step S140 in Embodiment 1.

Further, steps S261 through S263 are the same as steps S151 through S153 in Embodiment 1.

### ***Effects of Embodiment 2***

According to Embodiment 2, it is possible to generate a data model that satisfies a target value using a target value setting file for evaluation.

The generation unit 130 compares a data model evaluation value, the target value in the target value setting file, and the minimum value of a data model evaluation result after system start-up. Then, in any of the following cases, the generation unit 130 generates a new data model in such a way that the data model evaluation value becomes small based on the column call count, the column similarity degree, and the evaluated data model.

The generation unit 130 generates the new data model when the data model evaluation value exceeds the target value based on the target value setting file, but the data model evaluation value falls below the minimum value of the data model evaluation result after system start-up.

The generation unit 130 generates the new data model when the data model evaluation value exceeds the target value in the target value setting file, the data model evaluation value exceeds the minimum value of the data model evaluation result after system start-up, and the non-update count for the minimum value of the data model evaluation result after system start-up has not reached a threshold value.

Thereby, it is possible to generate a data model that is more efficient in communication and satisfies a target value.

The generation unit 130 compares the data model evaluation value, the target value in the target value setting file, and the minimum value of the data model evaluation result after system startup. Then, in any of the following cases, the generation unit 130 outputs a data model in which the data model evaluation value is a value that falls below the target value in the target value setting file, or outputs a data model in which the data model evaluation value is the minimum value of the data model evaluation result after system start-up.

The generation unit 130 outputs the data model when the data model evaluation value falls below the target value in the target value setting file.

The generation unit 130 outputs the data model when the data model evaluation value exceeds the target value in the target value setting file, the data model evaluation value exceeds the minimum value of the data model evaluation result after system start-up, and the non-update count for the minimum value of the data model evaluation result after system start-up has reached the threshold value.

Thereby, it is possible to output a data model that satisfies a target value, or a data model that does not satisfy the target value but that has high communication efficiency.

### ***Supplements to Embodiments***

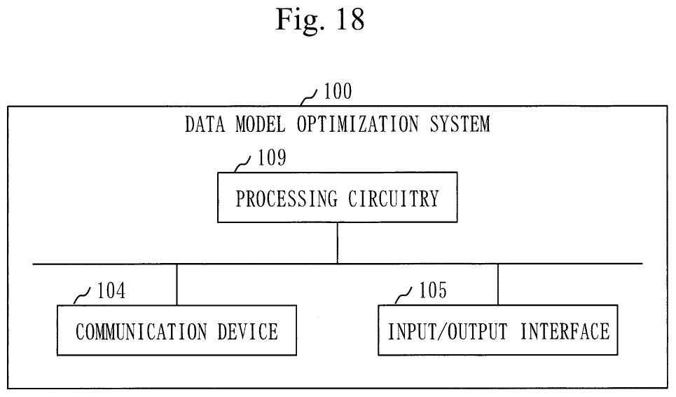

A hardware configuration of the data model optimization system 100 will be described based on FIG. 18.

The data model optimization system 100 includes processing circuitry 109.

The processing circuitry 109 is a piece of hardware that implements the calculation unit 110, the evaluation unit 120, and the generation unit 130.

The processing circuitry 109 may be dedicated hardware, or may be the processor 101 that executes programs stored in the memory 102.

When the processing circuitry 109 is the dedicated hardware, the processing circuitry 109 is, for example, a single circuit, a composite circuit, a programmed processor, a parallel programmed processor, an ASIC, an FPGA, or a combination of these.

ASIC is an abbreviation for Application Specific Integrated Circuit.

FPGA is an abbreviation for Field Programmable Gate Array.

The data model optimization system 100 may include a plurality of processing circuitry as an alternative to the processing circuitry 109.

In the processing circuitry 109, some functions may be implemented by dedicated hardware, and the remaining functions may be implemented by software or firmware.

In such a manner, a function of the data model optimization system 100 can be implemented by hardware, software, firmware, or a combination of these.

Each of the embodiments is an example of a preferred embodiment and is not intended to limit the technical scope of the present disclosure. Each of the embodiments may be implemented partially, or may be implemented in combination with another embodiment. The procedures described using the flowcharts or the like may be suitably modified.

“Unit” of each of the elements of the data model optimization system 100 may be interpreted as “process”, “step”, “circuit”, or “circuitry”.

### REFERENCE SIGNS LIST

100: data model optimization system; 101: processor; 102: memory; 103:
auxiliary storage device; 104: communication device; 105: input/output interface; 109:
processing circuitry; 110: calculation unit; 111: single call count calculation unit; 112:
set call count calculation unit; 113: similarity degree calculation unit; 120: evaluation
unit; 121: data model evaluation unit; 130: generation unit; 131: data model comparison
unit; 132: data model generation unit; 190: storage unit; 191: setting file; 200: data
processing system; 210: data platform; 211: data conversion unit; 212: database; 221:
application unit; 230: network storage; D1: data model; D2: data request; D3: inquiry;
D01: database configuration information; D02: data acquisition scenario; D03: target
value; D11: calculation information; D20: first edition model; D21: data model; D22:
evaluation information; D23: evaluation value; D24: reference value; D31: data model.

1. A data model optimization system comprising:
processing circuitry:
to calculate for each column in a plurality of tables, a call count which is the number of times that the column is called when data is acquired from a database according to a data acquisition scenario, based on database configuration information that indicates a configuration of the plurality of tables in the database and the data acquisition scenario in which the data to be acquired from the database is specified;
to calculate for each column set in the plurality of tables, a call count which is the number of times that the column set is called at the same timing when data is acquired from the database according to the data acquisition scenario, based on the database configuration information and the data acquisition scenario;
to calculate for each column set in the plurality of tables, a similarity degree between names of columns, based on the database configuration information; and
to generate a data model for representing data to be acquired according to the data acquisition scenario, using a structure that is suitable for processing of an application that uses the data, based on the call count for each column, the call count for each column set, and the similarity degree for each column set.

2. The data model optimization system according to claim 1, wherein
the processing circuitry, each time a data model is generated, evaluates the generated data model based on the data acquisition scenario, and calculates an evaluation value of the generated data model, and
the processing circuitry generates a new data model in such a way that evaluation that is represented by an evaluation value of the new data model becomes high.

3. The data model optimization system according to claim 2, wherein
the processing circuitry compares the latest evaluation value which is an evaluation value of the latest data model among generated data models, with a reference value which is an evaluation value that represents the highest evaluation among one or more evaluation values for one or more data models generated prior to the latest data model, and determines whether or not evaluation that is represented by the latest evaluation value is higher than evaluation that is represented by the reference value, and
the processing circuitry generates the new data model when the evaluation that is represented by the latest evaluation value is higher than the evaluation that is represented by the reference value.

4. The data model optimization system according to claim 3, wherein
the processing circuitry updates the reference value to the latest evaluation value when the evaluation that is represented by the latest evaluation value is higher than the evaluation that is represented by the reference value, and does not update the reference value to the latest evaluation value when the evaluation that is represented by the latest evaluation value is lower than the evaluation that is represented by the reference value, and
the processing circuitry generates the new data model when the evaluation that is represented by the latest evaluation value is lower than the evaluation that is represented by the reference value but a non-update count which is the number of times that the reference value has not been updated, has not reached a non-update threshold value.

5. The data model optimization system according to claim 4, wherein
the processing circuitry outputs a data model corresponding to the reference value when the non-update count has reached the non-update threshold value.

6. The data model optimization system according to claim 2, wherein
the processing circuitry compares the latest evaluation value which is an evaluation value of the latest data model among generated data models, with a target value, determines whether or not evaluation that is represented by the latest evaluation value is higher than evaluation that is represented by the target value, and outputs the latest data model when the evaluation that is represented by the latest evaluation value is higher than the evaluation that is represented by the target value.

7. The data model optimization system according to claim 6, wherein
the processing circuitry generates the new data model when the evaluation that is represented by the latest evaluation value is lower than the evaluation that is represented by the target value.

8. The data model optimization system according to claim 7, wherein
the processing circuitry compares the latest evaluation value with a reference value which is an evaluation value that represents the highest evaluation among one or more evaluation values for one or more data models generated prior to the latest data model, and determines whether or not the evaluation that is represented by the latest evaluation value is higher than the evaluation that is represented by the reference value, and
the processing circuitry generates the new data model when the evaluation that is represented by the latest evaluation value is higher than the evaluation that is represented by the reference value among cases where the evaluation that is represented by the latest evaluation value is lower than the evaluation that is represented by the target value.

9. The data model optimization system according to claim 8, wherein
the processing circuitry updates the reference value to the latest evaluation value when the evaluation that is represented by the latest evaluation value is higher than the evaluation that is represented by the reference value, and does not update the reference value to the latest evaluation value when the evaluation that is represented by the latest evaluation value is lower than the evaluation that is represented by the reference value, and
the processing circuitry generates the new data model when the evaluation that is represented by the latest evaluation value is lower than the evaluation that is represented by the reference value but a non-update count which is the number of times that the reference value has not been updated, has not reached a non-update threshold value among cases where the evaluation that is represented by the latest evaluation value is lower than the evaluation that is represented by the target value.

10. The data model optimization system according to claim 9, wherein
the processing circuitry outputs a data model corresponding to the reference value when the evaluation that is represented by the latest evaluation value is lower than the evaluation that is represented by the target value but the non-update count has reached the non-update threshold value.

11. The data model optimization system according to claim 1, wherein
the processing circuitry selects a column set whose call count is high based on a call count for each column set, as an object column set, and generates only for the object column set among column sets in the plurality of tables, a data model for representing data of each column in the object column set, using a structure that is suitable for processing of an application that uses the data.

12. The data model optimization system according to claim 1, wherein
the processing circuitry selects among combinations of columns whose call count is high, a column set whose similarity degree is high based on a call count for each column and a similarity degree for each column set, as an object column set, and generates only for the object column set among column sets in the plurality of tables, a data model for representing data of each column in the object column set, using a structure that is suitable for processing of an application that uses the data.

13. The data model optimization system according to claim 1, wherein
the processing circuitry selects among combinations of columns whose call count is high, a column set whose similarity degree is low based on a call count for each column and a similarity degree for each column set, as an object column set, and generates only for the object column set among column sets in the plurality of tables, a data model for representing data of each column in the object column set, using a separate structure that is suitable for processing of an application that uses the data.

14. A data model optimization method comprising:
calculating for each column in a plurality of tables, a call count which is the number of times that the column is called when data is acquired from a database according to a data acquisition scenario, based on database configuration information that indicates a configuration of the plurality of tables in the database and the data acquisition scenario in which the data to be acquired from the database is specified;
calculating for each column set in the plurality of tables, a call count which is the number of times that the column set is called at the same timing when data is acquired from the database according to the data acquisition scenario, based on the database configuration information and the data acquisition scenario;
calculating for each column set in the plurality of tables, a similarity degree between names of columns, based on the database configuration information; and
generating a data model for representing data to be acquired according to the data acquisition scenario, using a structure that is suitable for processing of an application that uses the data, based on the call count for each column, the call count for each column set, and the similarity degree for each column set.

15. A non-transitory computer readable medium storing a data model optimization program for causing a computer to execute:
a single call count calculation process to calculate for each column in a plurality of tables, a call count which is the number of times that the column is called when data is acquired from a database according to a data acquisition scenario, based on database configuration information that indicates a configuration of the plurality of tables in the database and the data acquisition scenario in which the data to be acquired from the database is specified;
a set call count calculation process to calculate for each column set in the plurality of tables, a call count which is the number of times that the column set is called at the same timing when data is acquired from the database according to the data acquisition scenario, based on the database configuration information and the data acquisition scenario;
a similarity degree calculation process to calculate for each column set in the plurality of tables, a similarity degree between names of columns, based on the database configuration information; and
a data model generation process to generate a data model for representing data to be acquired according to the data acquisition scenario, using a structure that is suitable for processing of an application that uses the data, based on the call count for each column, the call count for each column set, and the similarity degree for each column set.
